(19) United States
(12) Patent Application Publication
(10) Pub. No.: US 2018/0020109 A1
(43) Pub. Date: Jan. 18, 2018

(54) INFORMATION PROCESSING DEVICE

(71) Applicants: TOSHIBA TEC KABUSHIKI KAISHA, Tokyo (JP); KABUSHIKI KAISHA TOSHIBA, Tokyo (JP)

(72) Inventor: Ryosuke KOJIMA, Sunto Shizuoka (JP)

(21) Appl. No.: 15/212,756

(22) Filed: Jul. 18, 2016

(51) Int. Cl. H04N 1/00; H04N 1/32

(52) U.S. Cl. CPC H04N 1/00891; H04N 1/32101; H04N 1/00381; H04N 1/00251; H04N 2201/0094; H04N 2201/3205

(57) ABSTRACT

An information processing device includes a communication interface that is communicable with an image forming device, a camera interface configured to receive image data generated by a camera, and a controller. The controller is configured to, based on the image data received through the camera interface, determine whether or not a predetermined gesture is performed by a user during a predetermined period of time after controlling the communication interface to transmit a print command to the image forming device. Upon determining that the predetermined gesture is performed, the controller controls the communication interface to transmit, to the image forming device, a recovery command that directs the image forming device to be ready for printing.

### FIELD

Embodiments described herein relate generally to an information processing device.

### BACKGROUND

In the related art, a multi-functional peripheral (MFP) of one type has an authentication function. Such an MFP does not perform printing even if print data is received, and starts printing after completing an identification check using an IC card carried by a user for security purpose. An MFP of another type has a power saving function for reducing power consumption when the MFP is in a power saving mode and during waiting time. An MFP including both the authentication function and the power saving function starts a recovery process to transition from the power saving mode after the authentication with the IC card. For that reason, a user may need to keep waiting for a period of several seconds to several tens of seconds until the multi-functional peripheral completes a recovery process to transition from the power saving mode and becomes ready for printing.

### DESCRIPTION OF THE DRAWINGS

FIG. 1 illustrates a configuration of an image forming device control system according to an embodiment.

FIG. 2 illustrates an external appearance of an image forming device according to the embodiment.

FIG. 3 is a flowchart illustrating an operation of an information processing device of the image forming device control system.

FIG. 4 is a flowchart illustrating an operation of the image forming device.

### DETAILED DESCRIPTION

An information processing device includes a communication interface that is communicable with an image forming device, a camera interface configured to receive image data generated by a camera, and a controller. The controller is configured to, based on the image data received through the camera interface, determine whether or not a predetermined gesture is performed by a user during a predetermined period of time after controlling the communication interface to transmit a print command to the image forming device. Upon determining that the predetermined gesture is performed, the controller controls the communication interface to transmit, to the image forming device, a recovery command that directs the image forming device to be ready for printing.

Hereinafter an image forming device control system including an information processing device and an image forming device of an embodiment will be described.

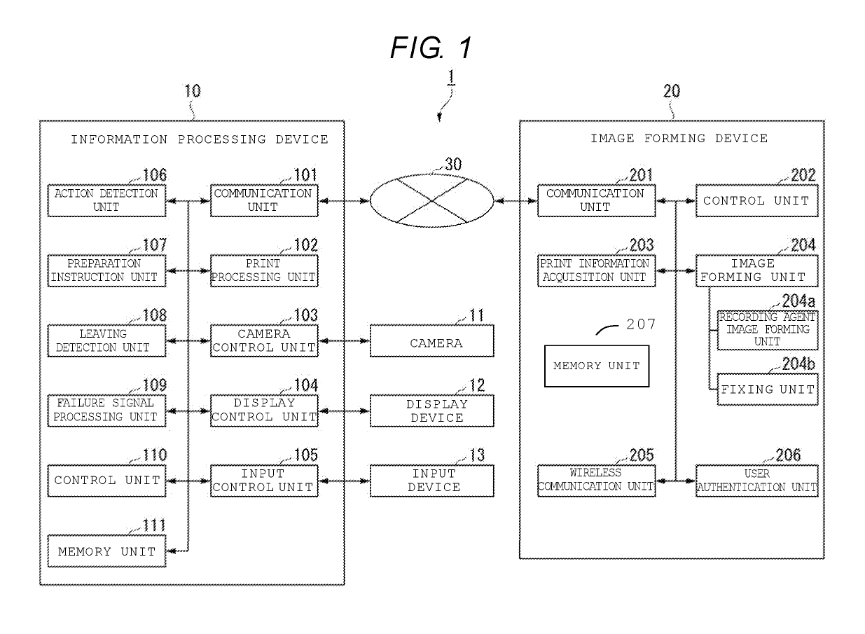

FIG. 1 illustrates an example of a configuration of an image forming device control system 1 of the present embodiment. The image forming device control system 1 has an information processing device 10, an image forming device 20, and a network 30.

The information processing device 10 is a terminal such as a personal computer, for example. The information processing device 10 is connected to a camera 11, a motion sensor, a display device 12 such as a liquid crystal display, and an input device 13 such as a mouse and a keyboard. The information processing device 10 outputs a print job (print command) to the image forming device 20 via the network 30.

The image forming device 20 is an image forming device such as a digital multi-functional peripheral, for example. The image forming device 20 includes, as operational modes, an ordinary mode and a power saving mode during which the power consumption is lower than during the ordinary mode. During the ordinary mode, since electrical power is supplied to each component of the image forming device 20, it is possible to start an image forming process or the like in response to a user instruction after a shorter response time. During the power saving mode, the power consumption is reduced by limiting electrical power so as to be supplied only to part of the components of the image forming device 20, reducing the set temperature of the fixing unit, and the like. If the image forming device 20 includes the fixing unit which fixes a toner image formed on a sheet by heating the toner image, it takes from several seconds to several tens of seconds to recover from the power saving mode to the ordinary mode. This is because it takes time to perform a warm-up operation to heat the fixing unit to a predetermined temperature.

The network 30 is a communication network including a wired communication network such as a local area network (LAN), a wireless communication network such as a wireless LAN, or a combination thereof.

The information processing device 10 includes a communication unit (communication interface) 101, a print processing unit 102, a camera control unit (camera interface) 103, a display control unit 104, an input control unit 105, an action detection unit 106, a preparation instruction unit 107, a leaving detection unit 108, a failure signal processing unit 109, a control unit (controller) 110, and a memory unit 111.

The memory unit 111 stores application software such as a printer driver or programs, and each unit 102-109 of the information processing device 10 is functionalized by the control unit (controller) 110 executing the application software.

The control unit (controller) 110 has a CPU to control each unit 102-109 of the information processing device 10 using the application software.

The communication unit 101 has an interface which communicates with the image forming device 20 via the network 30. The print processing unit 102 has a function of performing setting of printing in the image forming device 20, a function of converting the setting information and an image data (print data) made by the image processing device 10 to a print job construed by the image forming device 20, and a function of outputting the print job (print command) to the image forming device 20. The print job may be at least one of the setting information, an instruction of printing and the image data. The functions of the print processing unit 102 may be achieved by causing a computer (CPU) inside the information processing device 10 to execute a print driver (program), for example. The print processing unit 102 also has a function of transmitting a print job including identification information for identifying a user to the image forming device 20 via the communication interface 101.

The camera control unit 103 controls the camera 11, which is connected to the information processing device 10. The camera control unit 103 starts up the camera 11 in response to the print processing unit 102 transmitting a print job to the image forming device 20. The camera control unit 103 acquires image data output by the camera 11, and outputs the image data to the action detection unit 106 and the leaving detection unit 108 inside the information processing device 10.

The display control unit 104 generates screen information to be displayed on the display device 12, and outputs the generated screen information to the display device 12. The input control unit 105 receives input signals from the input device 13. Also, the input control unit 105 controls operations and the like of the input device 13.

The action detection unit 106 detects a specific action (gesture) of the user for instructing the image forming device 20 based on the image data generated by the camera 11. The action detection unit 106 is activated (starts operating) in response to the print processing unit 102 transmitting the print job to the image forming device 20. In the present embodiment, the instruction to the image forming device 20 is an instruction to perform a preparation operation (recovery process), which is necessary to perform the image forming process, for example. The preparation operation (recovery process) includes, for example, a warm-up operation for recovering from the power saving mode to the ordinary mode. The action detection unit 106 performs a process of detecting the specific action at a predetermined period (for example, several tens of times in one second).

The specific action performed by the user is, for example, a predetermined action of a body part of the user. The action of the body part of the user is, for example, waving of the user's hand to the left and right N times (where N is an arbitrary natural number) in a state in which the hand is upheld. When the action detection unit 106 detects the specific action of the user, the action detection unit 106 outputs a notice indicating that there is an instruction to recover to the normal mode, to the preparation instruction unit 107.

The preparation instruction unit 107 instructs the image forming device 20 to perform the recovery process based on the notice from the action detection unit 106. Specifically, the preparation instruction unit 107 transmits a preparation instruction (first recovery command) instructing execution of the recovery process to the image forming device 20 via the communication unit 101 and the network 30.

The leaving detection unit 108 detects whether or not the user has moved away from the information processing device 10 based on the image data generated by the camera 11. The leaving detection unit 108 performs the detection that the user moved away from the information processing device 10 when the specific action of the user is not detected by the action detection unit 106; however, the configuration is not limited thereto. The leaving detection unit 108 may detect that the user moved away from the information processing device 10 when the specific action of the user is not detected by the action detection unit 106 within a predetermined time period. The leaving detection unit 108 may detect that the user moved away from the information processing device 10 using, in addition to the image data generated by the camera 11, operation signals to the input device 13, and the like. The leaving detection unit 108 may detect that the user moved away from the information processing device 10 using an output signal from a dedicated motion sensor. When the leaving detection unit 108 detects that the user moved away from the information processing device 10, the leaving detection unit 108 outputs leaving detection information to the preparation instruction unit 107. The preparation instruction unit 107 transmits a preparation instruction (second recovery command) instructing the execution of the recovery process to the image forming device 20 based on the leaving detection information output by the leaving detection unit 108.

The failure signal processing unit 109 determines whether or not the communication unit 101 has received a print failure signal from the image forming device 20 within a predetermined time period. The print failure signal indicates that the print process corresponding to the print job was not performed by the image forming device 20 (indicating that the printing corresponding to the print job failed).

The print process is not performed in the image forming device 20, for example, when user authentication is not performed within a predetermined time period, when authentication of the user failed, and the like. When the failure signal processing unit 109 determines that the communication unit 101 received the print failure signal, the failure signal processing unit 109 instructs the action detection unit 106 to perform detection of an instruction operation.

With the failure signal processing unit 109, the information processing device 10 is capable of handling a case in which the user moved away from the information processing device 10 without performing the specific action after transmitting the print job. In this case, the user may perform the specific action after returning to the user's seat, and subsequently move to the image forming device 20. Accordingly, the information processing device 10 is capable of causing the image forming device 20 to start the recovery process for performing the printing of the print job which is received before the user moved away from the information processing device 10 at the timing of the specific action.

The image forming device 20 includes a communication unit (communication interface) 201, a control unit (controller) 202, a memory unit 207, a print information acquisition unit 203, an image forming unit (printing device) 204, a wireless communication unit 205, and a user authentication unit 206.

The memory unit 207 stores some programs which are operated each unit (203-207) of the image forming device 20.

The control unit (controller) 202 has a CPU and controls each unit (203-207) of the image forming device 20 using the program.

The wireless communication unit 205 performs short-range wireless communication with an IC card that stores identification information of the user when the IC card is positioned at (caused to approach) a predetermined location. The user authentication unit 206 performs authentication of the user based on the identification information of the user obtained from the IC card. The short-range wireless communication supported by the wireless communication unit 205 is, for example, wireless communication conforming to a Near Field Communication (NFC) standard.

The communication unit 201 communicates with the information processing device 10 via the network 30. The control unit 202 controls the operational mode of the image forming device 20 according to the preparation instruction received by the communication unit 201 so as to transition to the ordinary mode from the power saving mode. The print information acquisition unit 203 acquires a print job (print information) including the identification information of the user from the information processing device 10 via the network 30 and the communication unit 201. The print information acquisition unit 203 includes a memory and holds the acquired print job until a predetermined time has elapsed, or until predetermined conditions are satisfied.

The image forming unit 204 forms an image on a sheet based on the print job which is acquired by the print information acquisition unit 203. The image forming unit 204 includes a recording agent image forming unit 204a and a fixing unit 204b. The recording agent image forming unit 204a has a photosensitive drum, a charger, an exposure device, a developing device and a transfer device, and forms an image of a recording agent such as toner (a toner image) on a sheet. The fixing unit 204b has a heater and rollers, and fixes the toner image on the sheet by heating and pressurizing. The image forming unit 204 starts a warm-up operation of warming the fixing unit 204b to a predetermined temperature according to the control of the control unit 202 for switching the operational mode from the power saving mode to the ordinary mode.

The wireless communication unit 205 is a communication unit which performs short-range wireless communication conforming to the Near Field Communication (NFC) standard, and communicates with the IC card which is held by the user. The user authentication unit 206 acquires authentication information, which is information necessary for the user authentication, from the IC card via the wireless communication unit 205. The user authentication unit 206 performs the authentication of the user based on the acquired authentication information (i.e., determines whether or not the user having the IC card is same as the user who has sent the print job). The user authentication unit 206 outputs the authentication result to the control unit 202 and the image forming unit 204. When the authentication result of the user authentication unit 206 is authentication failure, the control unit 202 determines whether or not the preparation instruction is based on the detection that the user left the information processing device 10, by distinguishing the first recovery command and the second recovery command. The control unit 202 outputs the print failure signal to the information processing device 10 via the communication unit 201. When the authentication result of the user authentication unit 206 is authentication failure, the image forming unit 204 does not perform the print process based on the print job. When the authentication result of the user authentication unit 206 is authentication success, the image forming unit 204 performs the print process based on the print job.

According to the configuration described above, the information processing device 10 is capable of controlling the image forming device 20 to start the recovery process of recovering from the power saving mode in advance, before the user presents the IC card. When the image forming device 20 successfully authenticates the user based on the authentication information, the image forming device 20 performs the image forming process based on the print job.

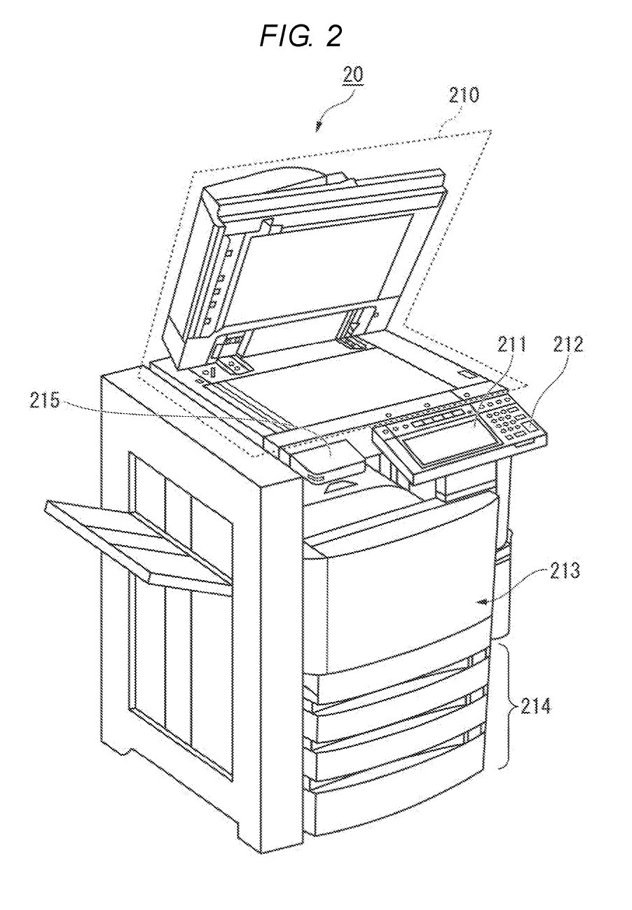

Next a configuration of the image forming device 20 of the present embodiment will be described. FIG. 2 illustrates an external appearance of the image forming device 20 according to the embodiment. The image forming device 20 includes an image reading unit 210, an operation display unit 211, a control panel 212, a printer unit 213, a sheet storage unit 214, and an authentication communication unit 215.

The image reading unit 210 reads an image on a sheet using a scanner, generates digital data, and formats the digital data as an image file. The sheet is, a medium such as a document, paper on which characters, images, and the like are printed, or the like, for example.

The operation display unit 211 is an image display device such as a liquid crystal display, an organic electro-luminescence (EL) display, or the like. The operation display unit 211 displays various information relating to the image forming device 20. The operation display unit 211 includes a function of a touch panel which receives input from the user. The user is capable of operating the image forming device 20 and setting the functions thereof through the operation display unit 211.

The control panel 212 includes a plurality of buttons. The control panel 212 receives inputs by the user. The control panel 212 outputs signals corresponding to the inputs by the user to the control unit 202 of the image forming device 20. The control panel 212 includes a button instructing the scanner to start reading the document, and a button to start the printing of the image data included in the print job received from an external device such as the information processing device 10.

The printer unit 213 includes the image forming unit 204 which forms an image on a sheet based on image data generated by the image reading unit 210. The image forming unit 204 forms an image on a sheet based on the image data received via the network 30 and the communication interface 201. The image forming unit 204 of the printer unit 213 forms the image through a following process, for example. That is, the image forming unit 204 forms an electrostatic latent image on a photosensitive drum based on the image data. The image forming unit 204 forms a recording agent image by causing the recording agent to selectively adhere to an electrostatic latent image. Toner is a specific example of the recording agent. The transfer unit of the image forming unit 204 transfers the recording agent image on the photosensitive drum onto the sheet. The fixing unit 204b of the printer unit 213 fixes the recording agent image onto the sheet by heating and pressurizing the sheet.

The sheet storage unit 214 stores sheets for the image formation by the printer unit 213. The authentication communication unit 215 is located at a predetermined location so that the IC card can be placed thereby to perform the user authentication. The wireless communication unit 205 is embedded in the authentication communication unit 215. The wireless communication unit 205 starts communication with the IC card within a predetermined distance (for example, several tens of centimeters) from the authentication communication unit 215.

The image reading unit 210 generates the image data based on intensity of light reflected by the image. The image reading unit 210 stores the image data in the print information acquisition unit 203. The stored image data may be used by the printer unit 213 to form an image on a sheet.

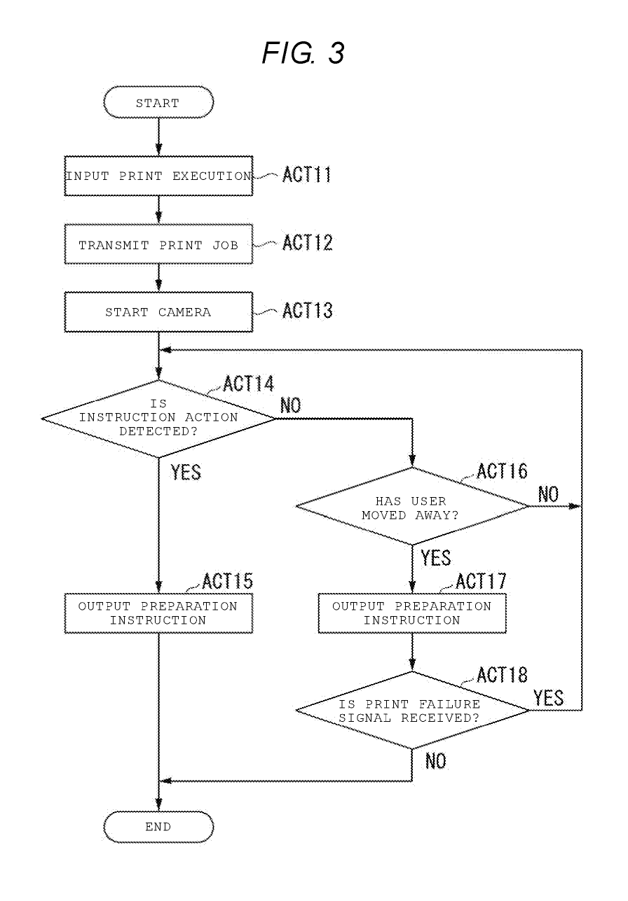

FIG. 3 is a flowchart illustrating an example of an operation of the information processing device 10.

First, the information processing device 10 receives an instruction, in response to a user operation of the input device 13 to execute the print process (ACT11). In response, the print processing unit 102 transmits a print job to the image forming device 20 via the communication unit 101 and the network 30 (ACT12). The camera control unit 103 starts up the camera 11 when the print job is transmitted (ACT13).

The action detection unit 106 executes the detection of the specific action of the user for instructing the image forming device 20 to perform the recovery process based on the image data generated by the camera 11 (ACT14). Here, if the specific action of the user is detected (YES in ACT14), the action detection unit 106 outputs the instruction to the preparation instruction unit 107. The preparation instruction unit 107 outputs a preparation instruction (first recovery command) to the image forming device 20 based on the instruction from the action detection unit 106 (ACT15). When the image forming device 20 receives the preparation instruction, the image forming device 20 starts the recovery process from the power saving mode.

In this manner, the information processing device 10 is capable of controlling the image forming device 20 to start the recovery process before the user goes to the location of the image forming device 20 and presents the IC card. Accordingly, the image forming device 20 is capable of shortening the time from when the user presents the IC card until the printed matter is output.

If the specific action of the user is not detected (NO in ACT14), the leaving detection unit 108 determines whether or not the user has moved away from the information processing device 10 based on the image data generated by the camera 11 (ACT16). Here, when it is determined that the user moved away from the information processing device 10 (YES in ACT16), the leaving detection unit 108 outputs the leaving detection information to the preparation instruction unit 107. The preparation instruction unit 107 outputs a preparation instruction (second recovery command) to the image forming device 20 based on the leaving detection information output by the leaving detection unit 108 (ACT17).

When it is determined that the user has not left (moved away from) the information processing device 10 (NO in ACT16), the process returns to ACT14, and the action detection unit 106 performs detection of the specific action of the user.

When the preparation instruction is output to the image forming device 20 in response to the leaving of the user, the communication unit 101 may receive a print failure signal from the image forming device 20. Therefore, the failure signal processing unit 109 determines whether or not the communication unit 101 has received a print failure signal from the image forming device 20 within a predetermined time period (ACT18). If the failure signal processing unit 109 determines that the print failure signal is received (YES in ACT18), the process returns to ACT14, and the action detection unit 106 detects of an instruction operation. If the failure signal processing unit 109 determines that the print failure signal is not received (NO in ACT18), the process of controlling the image forming device 20 is ended.

As described above, the information processing device 10 is capable of controlling the image forming device 20 to start the recovery process when it is detected that the user left the information processing device 10 after the transmission of the print job. Accordingly, the information processing device 10 is capable of performing control such that the image forming device 20 starts the recovery process before the user goes to the location of the image forming device 20 and presents the IC card.

The processes of FIG. 3 are processes in which the image forming device 20 performs the recovery process based on the detection of an instruction operation or the detection that the user left the information processing device 10; however, the configuration of the image forming device control system 1 is not limited thereto. For example, the information processing device 10 may control the recovery process in the image forming device 20 based only on the detection of an instruction operation. In this case, when specific action of the user is not detected (NO in ACT14), the process returns to ACT14 again, and the process flow continues the detection of the specific action of the user.

Also, the information processing device 10 may control the recovery process in the image forming device 20 based only on the detection that the user left the information processing device 10. In this case, the process flow of FIG. 3 is changed to perform ACT16 after ACT13. ACT14 and ACT15 of FIG. 3 are also deleted from this process flow.

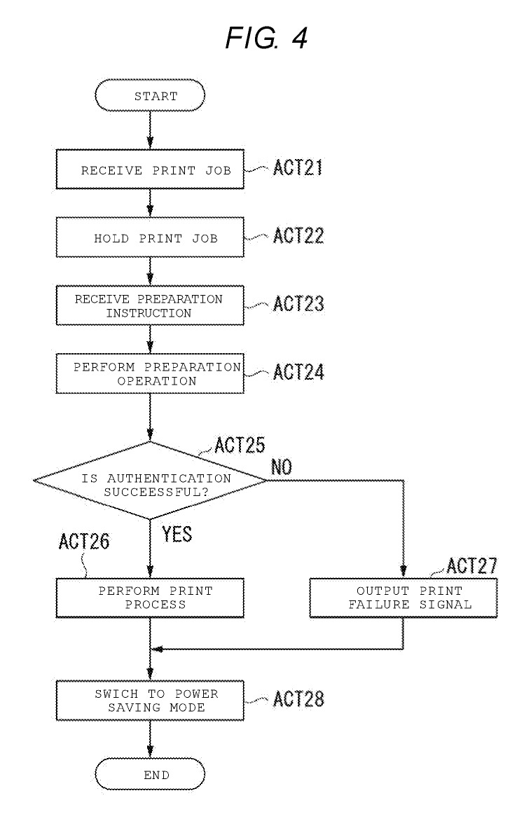

Next, an operation of the image forming device 20 will be described. FIG. 4 is a flowchart illustrating an example of the operation of the image forming device 20. Here, it is assumed that the image forming device 20 is in the power saving mode when the operation illustrated in FIG. 4 starts. The image forming device 20 is capable of receiving and holding a print job from the information processing device 10, when in the power saving mode.

As illustrated in ACT12 of FIG. 3, the information processing device 10 transmits the print job to the image forming device 20. In this manner, the communication unit 201 of the image forming device 20 receives the print job from the information processing device 10 via the network 30 (ACT21). The print information acquisition unit 203 holds the print job received by the communication unit 201 (ACT22).

As illustrated in ACT15 of FIG. 3, the information processing device 10 transmits the preparation instruction to the image forming device 20 when the specific action of the user is detected. Then, the communication unit 201 of the image forming device 20 receives the preparation instruction from the information processing device 10 via the network 30 (ACT23). The control unit 202 performs the preparation operation in which the operational mode of the image forming device 20 is switched from the power saving mode based on the preparation instruction received by the communication unit 201 (ACT24). That is, the image forming unit 204 performs the preparation operation such as the warm-up operation.

Here, it is assumed that the user presents the IC card to the authentication communication unit 215 of the image forming device 20, in order to output the printed matter corresponding to the print job. In response, the wireless communication unit 205 starts short-range wireless communication with the IC card. The user authentication unit 206 acquires authentication information, which is information necessary for the user authentication, from the IC card via the wireless communication unit 205. The user authentication unit 206 performs authentication of the user based on the acquired authentication information (ACT25).

When the authentication of the user is successful (authentication success, YES in ACT25), the image forming unit 204 performs the print process based on the print job which is held by the print information acquisition unit 203 (ACT26). After the completion of the print process, the control unit 202 switches the operational mode of the image forming device 20 to the power saving mode after a predetermined time has elapsed (ACT28).

When the authentication of the user fails (authentication failure, NO in ACT25), the control unit 202 outputs the print failure signal to the information processing device 10 (ACT27). Specifically, the control unit 202 outputs the print failure signal to the information processing device 10 via the communication unit 201 and the network 30. After outputting the print failure signal, the control unit 202 switches the operational mode of the image forming device 20 to the power saving mode after a predetermined time has elapsed (ACT28). In the flowchart of FIG. 4, when the authentication of the user fails (authentication failure), the process proceeds to ACT27; however, the configuration is not limited thereto. For example, even when the authentication process is not performed by the user authentication unit 206 after a predetermined period has elapsed from the start or end of the preparation operation, the process may proceed to ACT27.

In FIG. 4, the process of receiving the print job of ACT21 corresponds to a process of the information processing device 10 transmitting the print job in ACT12 of FIG. 3. In FIG. 4, the process of receiving the preparation instruction of ACT23 corresponds to a process of the information processing device 10 transmitting the preparation instruction in ACT15 and ACT17 of FIG. 3. In FIG. 4, the process of outputting the print failure signal of ACT27 corresponds to a process of the information processing device 10 receiving the print failure signal in ACT18 of FIG. 3.

As described above, after receiving the print job, the image forming device 20 receives the preparation instruction instructing the execution of the preparation operation from the information processing device 10 before performing the authentication process of the user. Accordingly, the image forming device 20 is capable of starting the preparation operation such as the warm-up operation before performing the authentication process of the user.

### Modification Example of Embodiment

The information processing device 10 of the embodiment described above is configured to detect the specific action of the user based on the image data generated by the camera 11; however, the configuration is not limited thereto. The specific action of the user may be detected based on an input signal from an input device such as a mouse. Alternatively, the specific action of the user may be detected based on a sensor signal of an infrared sensor, a distance sensor, or the like.

The image forming device 20 of the embodiment described above has a target temperature to which the fixing unit 204b is to be heated during the warm-up operation, which is the same as the temperature during the ordinary mode; however, the configuration is not limited thereto. For example, when heating the fixing unit 204b according to the preparation instruction caused by the detection that the user left the information processing device 10, the target temperature to which the fixing unit 204b is to be heated may be set to a temperature lower than the temperature during the ordinary mode. Such a temperature setting is effective when it is unlikely that the user will use the image forming device 20. Since the user may not use the image forming device 20, the fixing unit 204b is not heated more than necessary, and even if the user uses the image forming device 20, it is possible to transition to the ordinary mode in less time than recovering from the power saving mode.

The image forming device 20 of the embodiment described above is configured to perform the printing after authentication using an IC card; however, the configuration is not limited thereto. Even if the image forming device 20 is configured to perform the printing when a specific user is detected based on image data or the like generated by a camera, it is possible to apply the technique of performing the preparation operation in advance in the embodiment described above.

The information processing device 10 of the embodiment described above is configured such that the camera 11, the display device 12, and the input device 13 are separate from the information processing device 10; however, the configuration is not limited thereto, and the information processing device 10 may include at least one of the camera 11, the display device 12, and the input device 13. For example, the information processing device 10 may be configured to include a touch panel in which the display device and the input device are integrated.

The information processing device 10 of the embodiment described above detects the specific action of the user after executing the printing; however, the configuration is not limited thereto. The information processing device 10 may be configured to detect the specific action of the user at an arbitrary timing. For example, a camera application is started on the information processing device 10 before the user goes to make a copy using the image forming device 20. The camera application includes the functions of the camera control unit 103, the action detection unit 106, and the preparation instruction unit 107 which are illustrated in FIG. 1. The camera application outputs the preparation instruction to the image forming device 20 when the specific action of the user is detected based on the image data from the camera 11. Accordingly, the camera application is capable of causing the image forming device 20 to start the recovery process before the user presents the IC card to the image forming device 20 in order to make a copy.

According to at least one of the embodiments described above, the information processing device 10 is capable of controlling the image forming device 20 to start the preparation operation before the image forming device 20 performs the authentication of the user.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An information processing device, comprising:
a communication interface by which communication is established with an image forming device;
a camera interface configured to receive image data generated by a camera; and
a controller configured to
control the communication interface to transmit a print command to the image forming device in response to a user operation and then based on the image data received through the camera interface, determine whether or not a predetermined gesture is performed by a user during a predetermined period of time after controlling the communication interface to transmit the print command to the image forming device, and
upon determining that the predetermined gesture is performed, control the communication interface to transmit, to the image forming device, a recovery command that directs the image forming device to be ready for printing.

2. The information processing device according to claim 1, wherein the controller is further configured to
determine whether or not the user has moved away from the information processing device, after controlling the communication interface to transmit a print command to the image forming device, and
upon determining that the user has moved away from the image processing device, control the communication interface to transmit the recovery command to the image forming device.

3. The information processing device according to claim 2, wherein
the controller carries out determination of whether or not the user has moved away from the information processing device, upon determining that the predetermined gesture is not performed during the predetermined period of time.

4. The information processing device according to claim 2, wherein
the controller determines whether or not the user has moved away from the information processing device, based on the image data received through the camera interface.

5. The information processing device according to claim 2, wherein
the controller determines whether or not the user has moved away from the information processing device, based on operation or non-operation of the information processing device by the user for a predetermined period of time after the print command is controlled to be transmitted.

6. The information processing device according to claim 2, wherein
after the recovery command based on the determination that the user has moved away from the image processing device is transmitted, the controller is configured to determine whether or not the communication interface received a print failure signal from the image forming device during a predetermined time period, and
upon determining that the print failure signal is received, the controller repeats the determination of whether or not the predetermined gesture is performed.

7. The information processing device according to claim 2, wherein the recovery command based on determination that the predetermined gesture is performed and the recovery command based on determination that the user has moved away are different from each other.

8. The information processing device according to claim 1, wherein the communication interface transmits authentication information of the user along with the print command.

9. The information processing device according to claim 1, wherein the predetermined gesture includes a predetermined hand signal of the user.

10. An image forming device, comprising:
a printer;
a communication interface that is communicable with an external device to receive a print command and a recovery command that directs the printer to be ready for printing; and
a controller configured to carry out authentication of a user after reception of the print command by the communication interface and control the printer to carry out image forming upon successful authentication of the user, wherein
upon reception of the recovery command by the communication interface after the reception of the print command and before the successful authentication of the user, the controller directs the printer to be ready for printing.

11. The image forming device according to claim 10, wherein the printer includes a heater, and
the controller turns on or turns up the heater to direct the printer to be ready for printing.

12. The image forming device according to claim 11, wherein
upon unsuccessful authentication of the user, the controller is further configured to turn off or turn down the heater.

13. The image forming device according to claim 10, further comprising:
a reader configured to read authentication information included in a medium carried by the user, wherein
the controller carries out the authentication of the user based on the authentication information read by the reader.

14. The image forming device according to claim 10, wherein
the controller causes the printer not to carry out image forming upon unsuccessful authentication of the user.

15. The image forming device according to claim 10, wherein
upon unsuccessful authentication of the user, the controller is further configured to control the communication interface to transmit a print failure signal to the external device from which the print command was received.

16. A non-transitory computer readable medium comprising a program that is executable in a computing device to cause the computing device to perform a method for communicating with an image forming device, the method comprising:
transmitting a print command to the image forming device in response to a user operation;
receiving image data generated by a camera after the print command has been transmitted;
based on the image data, determining whether or not a predetermined gesture is performed by a user during a predetermined period of time after the print command was transmitted; and
upon determining that the predetermined gesture is performed, transmitting, to the image forming device, a recovery command that directs the image forming device to be ready for printing.

17. The non-transitory computer readable medium according to claim 16, wherein the method further comprises:
upon determining that the predetermined gesture is not performed, determining whether or not the user has moved away from the computing device; and
upon determining that the user has moved away from the computing device, transmitting the recovery command to the image forming device.

18. The non-transitory computer readable medium according to claim 16, wherein the method further comprises:
after the recovery command based on the determination that the user has moved away from the computing device is transmitted, determining whether or not a print failure signal is received from the image forming device; and
upon determining that the print failure signal is received, repeating determination of whether or not the predetermined gesture is performed.

19. The non-transitory computer readable medium according to claim 16, wherein
the predetermined gesture includes a predetermined hand signal of the user.
